(19) United States
(12) Patent Application Publication
(10) Pub. No.: US 2013/0309042 A1
(43) Pub. Date: Nov. 21, 2013

(54) THREADED FASTENER

(71) Applicant: Ming-Lai CHAO, Kaohsiung City (TW)

(72) Inventor: Ming-Lai CHAO, Kaohsiung City (TW)

(21) Appl. No.: 13/652,850

(22) Filed: Oct. 16, 2012

(30) Foreign Application Priority Data
May 16, 2012 (TW) 101209260

(51) Int. Cl. F16B 25/00

(52) U.S. Cl. 411/387.1

(57) ABSTRACT

A threaded fastener includes a top head portion, a shank, a thread and first and second flutes. The shank includes a threaded portion that extends axially along a central axis and a connecting portion that extends upwardly and axially along the central axis from the threaded portion to the top head portion. The thread extends upwardly and helically around an outer periphery of the threaded portion and along the central axis. The first flute is indentedly formed on the threaded portion and extends upwardly along the central axis. The second flute is indentedly formed on the threaded portion and above the first flute, and extends upwardly and axially along the central axis and opposite to the first flute.

### BACKGROUND OF THE INVENTION

1. Field of the Invention

The invention relates to a threaded fastener, more particularly to a threaded fastener having opposite flutes at different heights and adapted for drilling into an object.

2. Description of the Related Art

Referring to FIG. 1, a conventional threaded fastener 1 includes a head 12, a shank 11 extending axially from the head 12, a thread 13 extending helically around the shank 11, and a flute 14 indentedly formed on the shank 11. In use, the threaded fastener 1 is operable to directly drill into an object (not shown) with no pre-drilled holes. The purpose of providing the flute 14 on the threaded fastener 1 is: (1) the thread 13 is partially interrupted by flute 14 to form a discontinuous and incomplete thread, and thus, the shaving and drilling ability of the threaded fastener 1 can be promoted or enhanced; and (2) the flute 14 is capable of receiving shavings, and thus, deterioration of the drilling effect and speed of the threaded fastener caused by accumulation of the shavings can be avoided.

The number of the flute 14 is not restricted, and maybe two, three or more. For example, there is currently a threaded fastener (not shown) formed with two flutes. Although these two flutes have the same functions to assist the shaving and drilling ability of the threaded fastener and to accommodate the shavings, some disadvantages are encountered. Specifically, the design of the known threaded fasteners formed with two flutes fails to take dispositions of the flutes into consideration. For example, the flutes both extend upwardly from a drip tip of the threaded fastener, and are disposed at a same height relative the drip tip or disposed randomly. Consequently, the structural strength of the shank is insufficient and uneven. The stress distribution of the threaded fastener during drilling is uneven and the threaded fastener is likely to be damaged.

### SUMMARY OF THE INVENTION

Therefore, an object of the present invention is to provide a threaded fastener that can alleviate the aforesaid drawbacks of the prior art.

According to this invention, a threaded fastener includes: a top head portion; a shank including a threaded portion that extends axially along a central axis and a connecting portion that extends upwardly and axially along the central axis from the threaded portion to the top head portion; a thread that extends upwardly and helically around an outer periphery of the threaded portion and along the central axis; a first flute that is indentedly formed on the threaded portion and that extends upwardly along the central axis; and a second flute that is indentedly formed on the threaded portion and above the first flute and that extends upwardly and axially along the central axis and opposite to the first flute relative to the central axis.

### BRIEF DESCRIPTION OF THE DRAWINGS

Other features and advantages of the present invention will become apparent in the following detailed description of the preferred embodiment with reference to the accompanying drawings, of which:

FIG. 1 is a front view of a conventional threaded fastener;

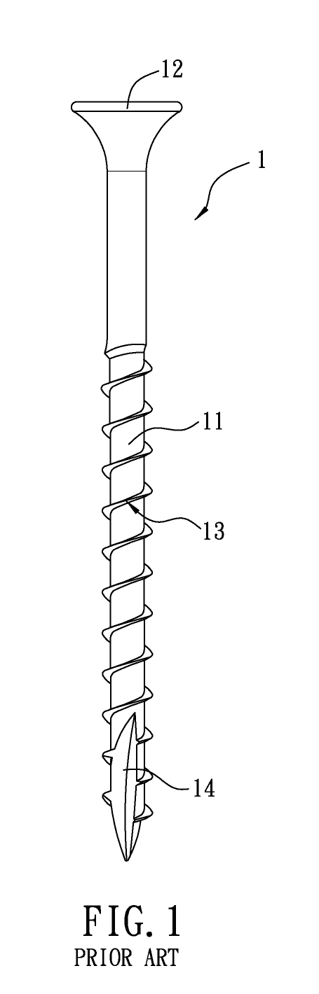

FIG. 2 is a perspective view illustrating the preferred embodiment of a threaded fastener according to this invention; and

FIG. 3 is a side view of the preferred embodiment.

### DETAILED DESCRIPTION OF THE PREFERRED EMBODIMENT

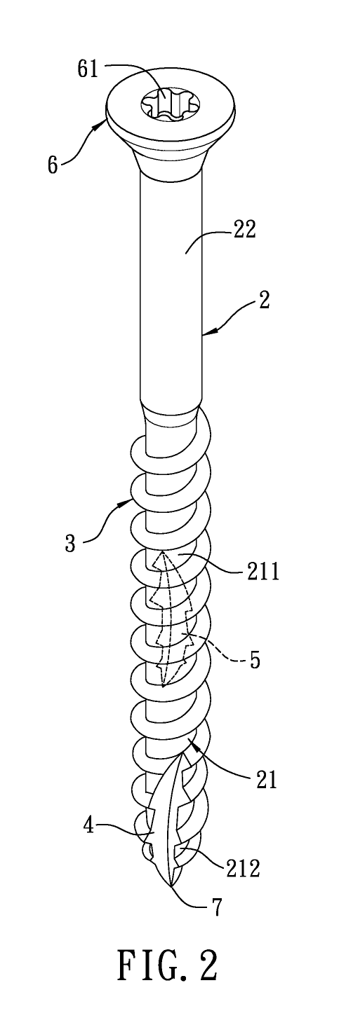

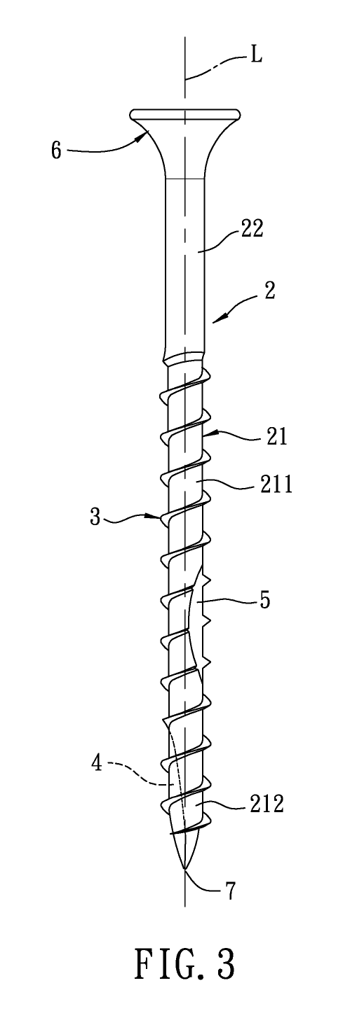

Referring to FIGS. 2 and 3, the preferred embodiment of a threaded fastener according to this invention includes a shank 2, a thread 3, a first flute 4, a second flute 5 and a top head portion 6.

The shank 2 includes a threaded portion 21 that extends axially along a central axis (L), and a connecting portion 22 that is cylinder-shaped and that extends upwardly and axially along the central axis (L) from the threaded portion 21 to the top head portion 6. In this embodiment, the threaded portion 21 has a main portion 211 that is cylinder-shaped, and an end portion 212 that is tapered downwardly away from the main portion 211.

The thread 3 extends upwardly and helically around an outer periphery of the threaded portion 21 and along the central axis (L).

The first flute 4 is indentedly formed on the threaded portion 21 and extends upwardly along the central axis (L). In this embodiment, the first flute 4 extends upwardly from the end portion 212 to the main portion 211. In other words, the location of the first flute 4 goes across the main portion 211 from the end portion 212 and is not formed with the thread 3.

The second flute 5 is indentedly formed on the threaded portion 21 and above the first flute 4. In other words, the height of the second flute 5 relative to a drip tip 7 is greater than that of the first flute 4. The second flute 5 extends upwardly and axially along the central axis (L), and is opposite to the first flute 4 relative to the central axis (L) and is formed on the main portion 211. Likewise, the second flute 5 is not formed with the thread 3.

The top head portion 6 is located at the top of the connecting portion 22 of the shank 2 and is formed with a groove 61. The groove 61 is provided for engagement with a hand tool such as a screwdriver so that the threaded fastener of this invention can be driven by the hand tool.

When the threaded fastener is used for drilling into an object (not shown) having no pre-drilled holes, the shaving and drilling ability of the threaded fastener can be promoted and enhanced by virtue of formation of the first and second flutes 4, 5. Moreover, since the shavings can be received in the first and second flutes 4, 5, problems caused by accumulation of the shavings can be avoided.

Furthermore, since the first and second flutes 4, 5 are oppositely and up-and-down disposed on the threaded portion 21 of the shank 2, compared with the conventional flutes disposed randomly or disposed at the same height with respect to the drill tip, the structural strength of the shank 2 is relatively even and balanced. Hence, the stress distribution of the threaded fastener of this invention during drilling is relatively even and the service life of the threaded fastener of this invention is prolonged.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A threaded fastener, comprising:
a top head portion;
a shank including a threaded portion that extends axially along a central axis, and a connecting portion that extends upwardly and axially along the central axis from said threaded portion to said top head portion;
a thread that extends upwardly and helically around an outer periphery of said threaded portion and along the central axis;
a first flute that is indentedly formed on said threaded portion and that extends upwardly along the central axis; and
a second flute that is indentedly formed on said threaded portion and above said first flute and that extends upwardly and axially along the central axis and opposite to said first flute relative to the central axis.

2. The threaded fastener as claimed in claim 1, wherein said threaded portion has a main portion and an end portion tapering downwardly away from said main portion, said first flute extending upwardly from said end portion to said main portion, said second flute being formed on said main portion.
